(19) United States
(12) Patent Application Publication
(10) Pub. No.: US 2013/0222461 A1
(43) Pub. Date: Aug. 29, 2013

(54) INKJET PRINT CALIBRATION USING TEST PATCHES AND DENSITOMETER

(71) Applicant: Michael E. Kaszynski, Stillwater, MN (US)

(72) Inventor: Michael E. Kaszynski, Stillwater, MN (US)

(21) Appl. No.: 13/823,455

(22) PCT Filed: Sep. 22, 2011
(86) PCT No.: PCT/US2011/052695

§ 371 Date: Apr. 24, 2013

Related U.S. Application Data
(60) Provisional application No. 61/386,075, filed on Sep. 24, 2010.
(60) Provisional application No. 61/386,070, filed on Sep. 24, 2010.

(51) Int. Cl. B41J 29/393

(52) U.S. Cl. CPC B41J 29/393
USPC 347/19

(57) ABSTRACT

An inkjet printing system including a media source supplying sheets of transparent film. An image processing module receives and converts input image data to output image data comprising a plurality of output pixels configured to select an ink profile. Predetermined ink profiles are selected representative of a series of test patches each having an expected density. A printhead is configured to eject droplets of available colors of ink onto a sheet of transparent film based on the selected ink profiles to produce the output pixels and an output image thereon, including the series of test patches. A transmissive densitometer measures the actual density value of each of the test patches, wherein the image processing module adjusts the output pixel values based on a deviations between the expected and actual density values of the series of test patches.

### FIELD OF THE INVENTION

The invention relates generally to the field of inkjet printing systems, and in particular to inkjet printing systems printing images on a transparent film. More specifically, the invention relates to a an inkjet printing system which employs test patches to dynamically calibrate half-tone print patterns employed by an inkjet printhead to print images on transparent film.

### BACKGROUND OF THE INVENTION

Inkjet printing systems create digital images by ejecting or propelling droplets of one or more colors of ink from a number of nozzles on a printhead onto a recording medium based on digital image data including a plurality of pixels representative of a desired digital image to be printed. The inks typically include a coloring agent, such as a pigment or dye, in a carrier fluid, such as a solvent or a glycol-water mixture, for example. The recording medium includes a wide variety of mediums, such as a paper and film, for example.

Films, which are often used in medical imaging applications for the production of digital images from digital image data generated by magnetic resonance (MR), computed topography (CT), and other types of scanners, typically include at least one image receiving layer, which receives the ink droplets from the inkjet printhead, and a support substrate, such as a vinyl or polymeric material, for example, wherein the support substrate can be opaque or transparent. An opaque support is employed for films that can be viewed using light reflected by a reflective backing, while a transparent support is used in films that can be viewed using light which is transmitted through the film.

Some medical imaging applications require high image densities. For a reflective film, high image densities are achieved by virtue of the light being absorbed on both its path into the imaged film and on its path out the imaged film from the reflective backing. For transparent films, because of the lack of a reflective backing, achievement of high image densities typically requires application of larger volumes of ink than required for opaque films.

While inkjet printing systems are widely employed in many applications, including medical applications where printing is done on film, the quality of the printed digital image can be adversely impacted by many factors such as the type of ink, the age of the ink, the type of film (e.g. opaque and transparent), the age of the film (e.g. the same film can exhibit different imaging properties as it ages), the film lot (e.g. the same type of film from different production lots can exhibit different properties), environmental conditions (e.g. temperature and humidity), and the volume of ink employed (e.g. larger volumes of carrier fluids are removed over a longer period of time when larger volumes of ink are used). Such factors can constantly vary and adversely impact the quality and consistency of the printed image.

While such systems may have achieved certain degrees of success in their particular application, there is a need to improve inkjet printing systems, particularly those used to print medical images on transparent film, in order to reduce the adverse impact on image quality associated with varying printing conditions.

### SUMMARY OF THE INVENTION

An object of the present invention is to provide an inkjet printing system employing test patches and a densitometer to calibrate an inkjet printhead to compensate for dynamic factors adversely affecting the quality of a printed digital image.

Another object of the present invention is to dynamically calibrate an inkjet printhead to maintain the quality of a printed digital image over time, in particular, monochromatic digital medical images printed on transparent film.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided an inkjet printing system including a media source supplying sheets of transparent film, and an image processing module configured to receive and convert input image data to output image data comprising a plurality of output pixels, each output pixel having a pixel value, and configured to select for each output pixel, based on the pixel value, an ink profile from a set of predetermined ink profiles associated with each pixel value, wherein the image processing module, in response to an initiating event, selects predetermined ink profiles representative of a series of test patches each having an expected density. The inkjet printing system further includes an inkjet printer including a printhead configured to eject droplets of one or more available colors of ink onto a sheet of transparent film based on the selected ink profiles so as to produce the output pixels and an output image thereon, including the series of test patches, and a transmissive densitometer which measures an actual density value of each of the test patches from the transparent film, wherein the image processing module adjusts the output pixel values based on a deviations between the expected and actual density values of the series of test patches. According to one aspect of the invention, the densitometer is integral to the inkjet printer.

According to one aspect of the invention, the output image data comprises monochromatic image data, and the expected densities of the series of test patches comprise gray scale densities, each test patch having a different expected gray scale density. According to one aspect, the series of test patches represent discrete gray scale density samples across a range of gray scale densities capable of being printed by the printhead, and the image processing module derives a curve of actual density values across the range of gray scale densities from the measured actual gray scale density values of the test patches, wherein the image processing module forms a correction model based on differences between the curve of actual density values and a curve of expected density values across the range of gray scale densities, and wherein the image processing module adjusts pixel values of the output pixels based on the correction model so that actual density values of printed output pixels substantially matches expected density values.

According to one aspect of the invention, the printhead prints a plurality of series of test patches in response to the initiating event, and the image processing module adjusts the output pixel values based on a deviations between the expected density values of the test patches and average values of the actual density values of each of the series of test patches.

According to one aspect of the invention, the output image data comprises color image data, and the series of test patches comprise a plurality of series of test patches, with each series of test patches representing densities across a range of densities for each available color of the printhead. According to one aspect of the invention, the image processing module adjusts the pixel values of each color of the output pixels based on deviations between the expected and actual density values of the series of test patches for each available color of the printhead.

According to one aspect of the invention, the initiation event comprises a calibration request by a user of the inkjet printing system. According to one aspect of the invention, the initiation event comprises a change in a type and/or manufacturing lot of the transparent film. According to one aspect of the invention, the initiation event comprises the elapsing of a specified duration of time.

According to one aspect of the invention, the inkjet printing system includes an image sensor configured to read parameters associated with the sheets of transparent film from indicia affixed thereto, the parameters including indications of film type and film manufacturing lot. According to one aspect of the invention, the image processing module develops a correction model for each combination of film type and film manufacturing lot based on deviations between expected and actual density values of a series of test patches associated with each combination of film type and film manufacturing lot.

According to one aspect of the invention, there is provided a monochromatic inkjet printing system including a media source providing sheets of transparent film, and an image processing module receiving and converting input image data to output image data comprising a plurality of output pixels, each output pixel having a gray scale density value, and configured to select for each output pixel a predetermined ink profile corresponding to the gray scale gray scale density value, and in response to an calibration event, configured to select a series of predetermined ink profiles representative of a series of test patches each having an expected gray scale density. The monochromatic inkjet printing system further includes an inkjet printer including a transmissive densitometer and printhead, the printhead configured to eject droplets of one or more available colors of ink onto a sheet of transparent film based on the selected ink profiles to print the output pixels and a corresponding image formed thereby on the transparent film and to print the test patches thereon in response to the calibration event, wherein densitometer is configured to measure an actual gray scale density value of each of the printed test patches, and wherein the image processing module adjusts the gray scale density value of the output pixels based on differences between the expected and actual gray scale density values of the series of test patches.

According to one aspect of the invention, there is provided a method of inkjet printer calibration including printing a series of test patches on a sheet of transparent film with a printhead of the inkjet printer, each test patch having a different expected gray scale density value, the series of test patches together representing discrete gray scale density values across a full range of gray scale density values capable of being printed by the printhead, measuring the actual gray scale density of each of the test patches with a transmissive densitometer, determining a correction model based on differences between the expected and actual gray scale density values of the test patches, and adjusting pixel values of pixels of monochromatic image data to be printed by the printhead using the correction model so that actual gray scale values of the printed pixels substantially matches expected values of the pixels of monochromatic image data.

By printing with an inkjet printhead and measuring with a transmissive densitometer the density of one or more series of test patches on a sheet of transparent film, and making adjustments to pixel values of output pixels to be printed by an inkjet printer based on differences between the measured density values and expected density values of the series of test patches, the inkjet printing system and inkjet printing system calibration methods described herein can dynamically compensate for a plurality of factors that would otherwise adversely impact the quality of the printed image on the transparent film.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a block and schematic diagram generally illustrating an inkjet printing system employing test patches and a densitometer according to one embodiment of the present application.

FIG. 2 shows illustrative examples of ink profiles of half-tone patterns for an example 4-color printhead for forming a desired pixel density.

FIG. 3 shows an illustrative example of gray scale test patches on a border of a sheet of imaging media.

FIG. 4 shows a graph illustrating an example of measured optical gray scale densities relative to expected optical gray scale densities.

FIG. 5 shows a flow diagram illustrating a method of inkjet print calibration employing test patches and a densitometer according to one embodiment of the present application.

### DETAILED DESCRIPTION OF THE INVENTION

The following is a detailed description of the preferred embodiments of the invention, reference being made to the drawings in which the same reference numerals identify the same elements of structure in each of the several figures.

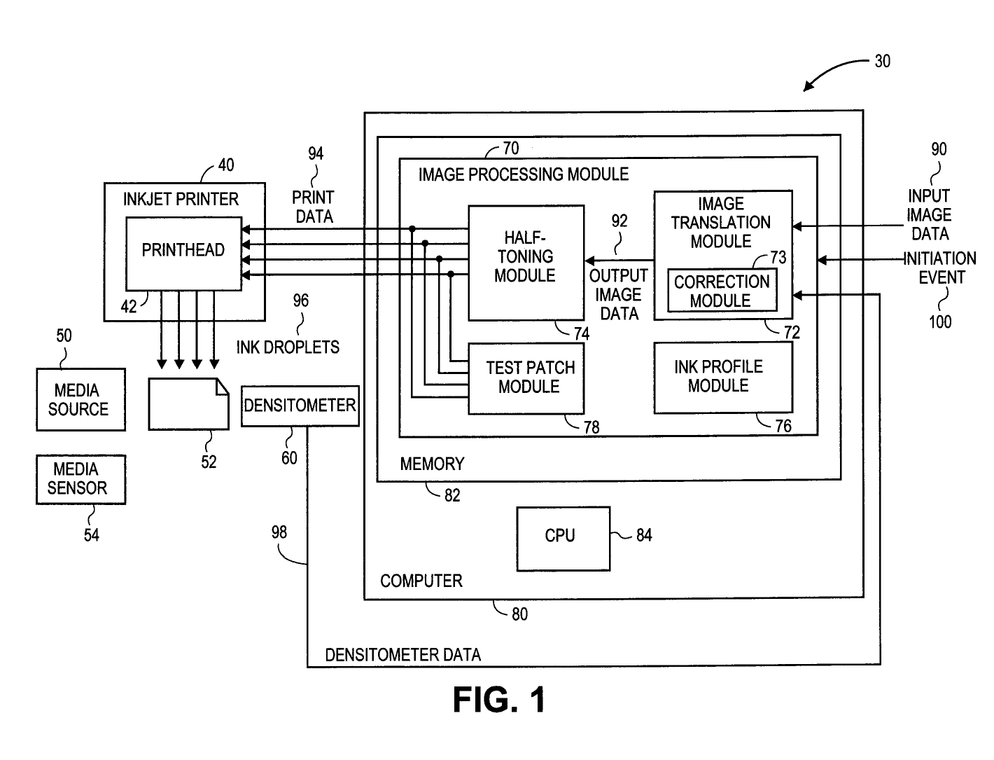

FIG. 1 is a block and schematic diagram generally illustrating an example of an inkjet printing system 30 configured to print test patches and employing a densitometer to measure a density of said test patches in order to adjust the fashion in which ink droplets are ejected from a printhead to compensate for factors that would otherwise compromise image quality according to embodiments of the present application as described herein.

According to the embodiment of FIG. 1, inkjet printing system 30 includes an inkjet printer 40 having a printhead 42, a media source 50 providing sheets of imaging media 52, a densitometer 60, and an image processing module 70. According to one embodiment, media source 50 comprises a cassette which provides sheets of transparent film 52 to inkjet printer 40. According to one embodiment, such cassette is configured to be inserted into inkjet printer 40.

According to one embodiment, image processing module 70 comprises computer executable code residing in a memory 82 of a computer 80, such as a laptop, and which is executable by a central processing unit 84. According to one embodiment, image processing module 70 includes an image translation module 72, a half-toning module 74, ink profile module 76, and a test patch module 78. According to other embodiments, image processing module 70 is implemented in hardware, software, firmware, or any combination thereof, separate from memory 82 and central processing unit 84. For example, image processing module 70 may be implemented as an application specific integrated circuit (ASIC).

In operation, image processing module 70 receives input image data 90, including a plurality of input pixels, captured by an image capturing device, such as an MRI or other medical scanning device, for example. Input image data 90 can be received directly from the image capture device or from a variety of digital storage media and be received by any number of methods such as via standard or proprietary wired interfaces, wireless connections, and portable devices such as CD and flash memory, for example. According to one embodiment, input image 90 is metadata associated with the image, such as a medical image communicated using the standard Digital Imaging and Communications in Medicine (DICOM), for example.

Image processing module 70 is configured to convert input image data 90 into a format for printing by printhead 42 of inkjet printer 40. Depending on the size of the image represented by input image data 90, image translation module 72 may need to resize the input image to a size which is compatible with the resolution of inkjet printer such that output image data 92 provided by image translation module 72 may have a number of output pixels that is different from the number of input pixels. If the number of output pixels is larger than the number of input pixels, each input pixel will be represented by more than one output pixel. If the number of output pixels is smaller than the number of input pixels, each output pixel will represent more than one input pixel.

Additionally, image translation module 72 may need to perform a color translation to translate the pixel values of the pixels of input image data 90 to pixel values supported by inkjet printer 40. For example, input image data 90 may have 12-bit pixel values representing a color or bit depth of 4,096 colors, while inkjet printer 40 is capable of supporting 8-bit pixel values representing a color or bit depth of 256 colors. According to such an example, image translation module 72 maps the 4,096 colors of the input image data 90 to the 256 colors supported by inkjet printer 40, such that more than one pixel value of input image data 90 is mapped to a single color or bit value of inkjet printer 40. Similarly, if inkjet printer 40 has a bit depth which is greater than that of the pixel values of input image data 90, image translation module 72 may map one pixel value of input image data 90 to more than one color or bit value of inkjet printer 40 using interpolation techniques based on the pixel values of adjacent input pixels in the input image. It is noted that algorithms for performing such image resizing and color translation are known in the art.

The potentially resized and color adjusted input image data 90 is provided by image translation module 72 as output image data 92 comprising a plurality of output pixels, each output pixel having an output pixel value. According to one embodiment, the output image data 92 represents monochromatic image data, with each pixel value representing a different gray scale or density value. For example, according to one embodiment, output image data 92 includes output pixels having 8-bit pixel values, such that each pixel has one of 256 potential density values.

Inkjet printers, such as inkjet printer 40, reproduce images through a process commonly referred to as half-toning. According to such a process, for each pixel, the inkjet printhead, such as printhead 42, prints a specified pattern of dots for one or more of the available ink colors of the printhead such that the pattern of dots for each of the printed colors combine to produce on the sheet of transparent film 52 the color or gray scale density in accordance with the pixel value of the pixel. As defined herein, an ink profile is a set of dot or half-tone patterns for up to each of the available printhead color, that when combined, will reproduce the desired color or gray scale density in accordance with the pixel value of the output pixel. It is noted that for a given printhead, more than one ink profile may be capable of producing a given pixel or density value.

For example, according to one embodiment, printhead 42 is a 4-color printhead (e.g. cyan, magenta, yellow, and black, commonly referred to as CMYK), and each of the output pixels has an 8-bit monochromatic pixel value, meaning that each pixel can represent one of 256 gray scale densities (i.e. 2⁸). For example, a first output pixel could have a pixel value of a gray scale density of 130 while a second output pixel could have a pixel value equating to a gray scale density of 50. As noted above, more than one ink profile for the 4-color CYMK printhead may be capable of producing a given density value.

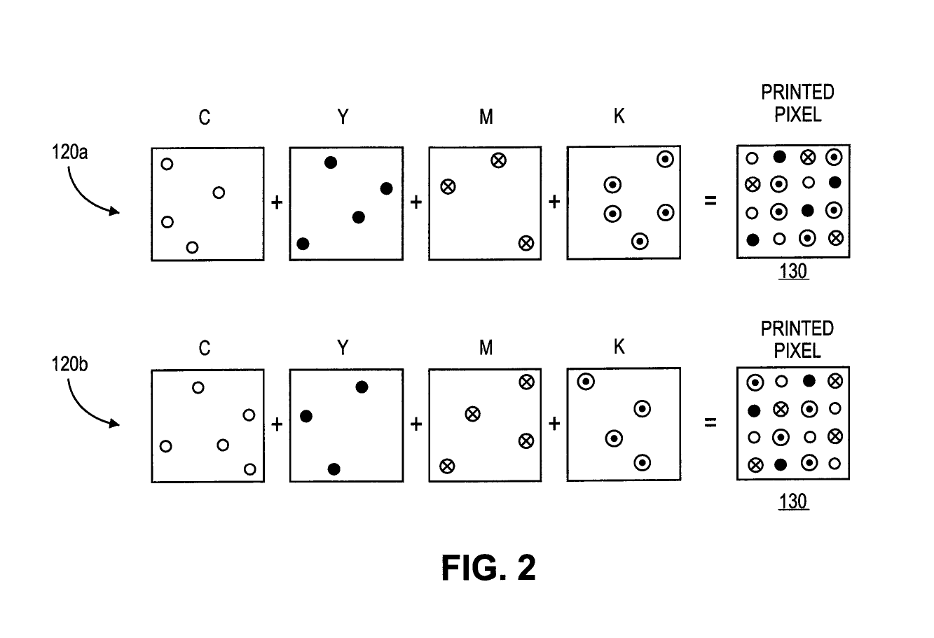

FIG. 2 is an illustrative example of two different ink profiles 120a and 120b for the 4-color CYMK printhead that will produce the same gray scale density value, such as the density value of 130 for the first pixel described above. It is noted that the ink patterns and ink volumes for each of the colors C, Y, M, and K, vary between ink profiles 120a and 120b, but that each ink profile results in the same density value of 130 for the pixel, although the tint/hue of the pixel may vary. Other ink profiles may be possible for the same pixel density of 130. It is noted that ink profiles 120a and 120b are clearly for illustrative purposes and do not represent actual half-tone patterns. It is further noted that inkjet printers having printheads with more than four ink colors are commercially available (e.g. 6 color, 8 color, 12 color, etc.). Accordingly, ink profiles containing additional colors with associated patterns would be similar for printheads employing more than four ink colors.

Returning to FIG. 1, according to one embodiment, ink profile module 76 stores sets of predetermined ink profiles compatible with the particular inkjet printer 40 being employed which instruct printhead 42 to produce each of the available colors or gray scale density values associated therewith, such as the 256 gray scale values associated with 8-bit output pixel values (i.e. 0 to 255) described by the example above. According to one embodiment, each pixel value has an associated set of ink profiles, with each set on ink profiles containing one or more ink profiles which will result in printhead 42 ejecting ink droplets of one or more colors in patterns that will, together, produce the corresponding pixel value, such as a gray scale density value, on transparent film 52.

Upon receiving output image data 92 from image translation module 72, half-toning module 74, for each pixel, selects one ink profile from the set of predetermined ink profiles associated with the pixel value stored in ink profile module 76, and provides the selected ink profile in the form of droplet or print data 94 to inkjet printer 40. Printhead 42 then ejects ink droplets 96 for each pixel onto transparent film 52 in accordance with the dot patterns for each of the printhead colors of the selected ink profile to produce each pixel and, thus, the desired image on transparent film 52.

As described earlier, the actual printed pixel value achieved on the sheet of transparent film 52, such as the density value when performing monochromatic printing, may deviate from the expected pixel value associated with a given ink profile for a variety of reasons such as the type of ink, the age of the ink, the type of film (e.g. opaque and transparent), the age of the film (e.g. the same film can exhibit different imaging properties as it ages), the film lot (e.g. the same type of film from different production lots can exhibit different properties), environmental conditions (e.g. temperature and humidity), and the volume of ink employed (e.g. larger volumes of carrier fluids are removed over a longer period of time when larger volumes of ink are used).

In order to compensate for these and other factors which adversely impact the quality of the printed image on transparent film 52, inkjet printing system 30, in response to an initiation event 100, prints a series of test patches on transparent film 52. According to one embodiment, in lieu of providing print data 94 representative of output image data 92 received from image translation module 72, image processing module 70 provides print data 94 representing predetermined ink profiles stored in test patch module 78, wherein the predetermined ink profiles are representative of a series of test patches, with each of the test patches having a different expected density.

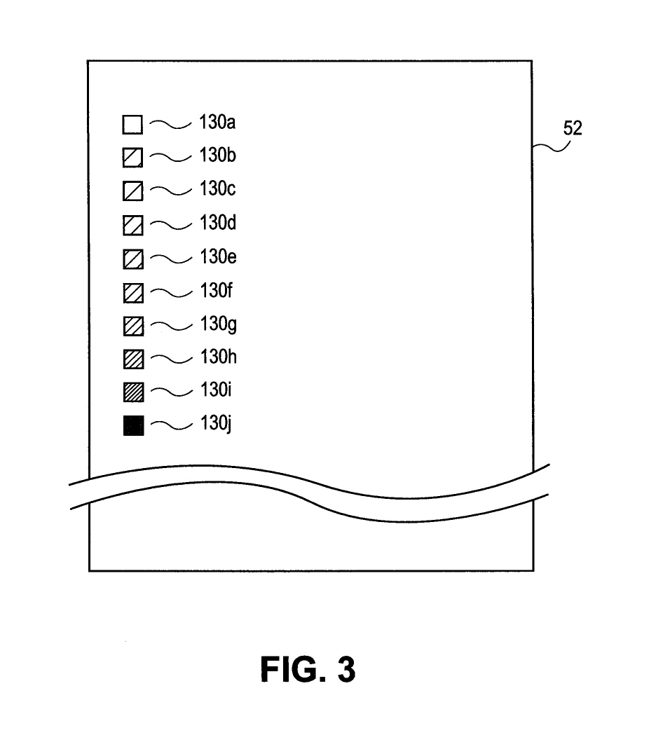

FIG. 3 shows an example of test patches 130a to 130j printed along an edge of a sheet of transparent film 52. As illustrated, each of the test patches 130a to 130j has a different optical density with the series of test patches 130a to 130j representing a gradient across the entire range of potential printed gray scale values, such as a range of 0 to 255 for 8-bit pixel values. According to one embodiment, test patches 130a to 130j are printed on a dedicated sheet of transparent film 52. According to one embodiment, test patches 130a to 130j are printed along an edge of a sheet of transparent film 52 on which a desired output image will also be printed.

According to one embodiment, each test patch 130a-130j comprises a plurality of pixels, each pixel printed using a same ink profile and together forming the associated test patch. Although illustrated in FIG. 3 as comprising ten test patches 130a to 130j, different number of test patches may be employed, so long as enough test patches are employed to give an accurate sampling/testing of the gray scale range. For example, according to one embodiment, 21 test patches are employed across a gray scale density range of 0 to 255 (i.e. an 8-bit gray scale range). The size of and spacing of the test patches may vary as well. According to one embodiment, test patches are not printed at equal intervals across the gray scale range, but rather more test patches are printed at the upper end of the gray scale range than at the low end.

Transmissive type densitometer 60 is then employed to measure the actual density of each of the test patches 130a to 130j printed on the sheet of transparent film 52 by providing a light source having a known output incident upon a given test patch and measuring with a sensor, such as a photodiode, the amount of light energy passing through the test patch. The measured densities of each of the test patches is provided to image translation module 72 as densitometer data 98. Again, as described above with respect to input image data 90, densitometer data 98 can be transmitted to image processing module 70 any number of ways, including via standard or proprietary wired interfaces, wireless connections, and portable devices such as CD and flash memory, for example. According to one embodiment, densitometer 60 is internal to and is an integral part of inkjet printer 40.

According to one embodiment, image translation module 72 converts the measured density for each of the test patches, such as test patches 130a-130j to optical densities. Image translation module 72 then compares the measured optical density of each test patch to the expected optical density (i.e. the optical density that was expected to be achieved by each of the printed test patches), and adjusts the pixel values of the output pixels of output image data 92 provided to half-toning module 74 based on the comparison such that the actual printed values of the output pixels match the expected values.

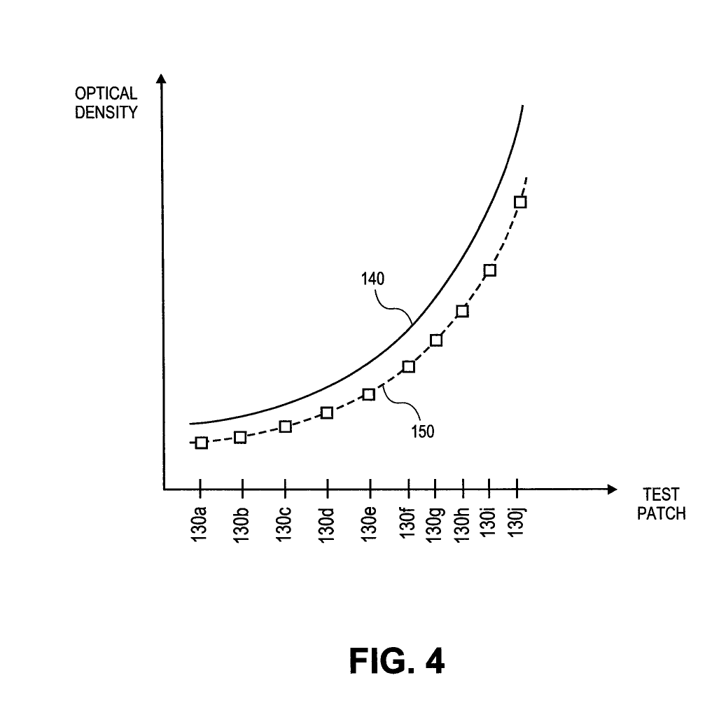

FIG. 4 shows a graph illustrating a curve 140 of expected gray scale values associated with ink profiles used to print each of the gray scale density values of a range of gray scale density values, such as the 0 to 255 gray scale density values of the above described example. According to one embodiment, image translation module 72 plots the measured optical densities of each of the test patches, such as test patches 130a-130j, with each measured optical density indicated as a square. Image translation module 72 then performs a curve fit to the measured optical densities to produce a curve 150, indicated by dashed lines, which represents the actual printed densities on transparent film 52 across the full range of gray scale densities. Based on the differences in values between curves 140 and 150, image translation module 72 can adjust the pixel values of the output pixels of output image data 92 provided to half-toning module 74 so that selection of ink profiles can be made that result in print data 94 being provided to printhead 42 so that ink droplets 96 disposed on transparent film 52 more closely match the desired gray scale densities.

For example, according to one embodiment, using the difference in values between curves 140 and 150, as illustrated by FIG. 4, image translation module 72 is able to determine an error between the expected optical density and the measured optical density for each gray scale value (e.g. 0-255 values). Based on the determined error, image translation module is able to provide a correction factor or correction mapping for each gray scale value, such as by mapping the initial gray scale value to a corrected gray scale value. According to one embodiment, such correction data is stored in a correction module 73. For example, if the expected gray scale pixel value of 120 was printed by printhead 42 with an actual/measured gray scale value of, say, 116, image translation module 72 can map expected gray scale pixel values of 120 to an expected gray scale pixel value which provides an actual/measured gray scale value of 120, such as a pixel value of 123 (assuming the actual/measured gray scale of the original pixel value of 123 results in the printing of a gray scale value of 120).

The density adjusted output image data 92 is then provided to half-toning module 74 which selects ink profiles from ink profile module 76 based on the density adjusted pixel values. The print data 94 then provided to inkjet printer 40 will result in printhead 42 ejecting ink droplets 96 onto transparent film 52 that form pixels having actual optical densities that match the originally expected optical densities.

According to one embodiment, rather than printing a single set of gray scale test patches on transparent film, such as test patches 130a-130j, multiple sets of test patches 130a-130j are printed and measured. The measured values of the corresponding test patches of each set of test patches are then averaged to determine the curve 160 of FIG. 4.

Initiation event 100 comprises a plurality of events. According to one embodiment, initiation event 100 comprises a request by a user of inkjet printing system 30 to calibrate the color or density output of inkjet printer 42. According to one embodiment, initiation event 100 is generated by image processing module 70 after a set duration has elapsed, such as 7 days, for example. According to one embodiment, initiation event 100 comprises a new type or a new manufacturing lot of film 52 being used.

For example, according to one embodiment, inkjet printing system includes a media sensor 54 configured to read parameters associated with sheets of transparent film 52, such as the type of film (e.g. a clear support substrate, or a “blue” support substrate) and the manufacturing lot from which the film was made. It is noted that transparent films having a clear support substrate will exhibit different imaging characteristics than transparent films employing a blue support substrate. Additionally, films from different manufacturing lots will also exhibit different imaging characteristics.

In one embodiment, media sensor 54 comprises a bar code reader configured to read parameters associated with transparent film 52 from a film cassette in which the film is contained and which includes a bar code which indicates, among other things, the type of film, and the manufacturing lot. In one embodiment, media sensor 54 is a bar code reader which reads film parameter data affixed to individual sheets of film 52. According to one embodiment, media sensor 54 is a radio frequency (RF) receiver/transmitter configured to read film parameters affixed either to a film cassette or cartridge or to individual sheets of film 52 in the form of an RF tag device.

Regardless of the type of media sensor, according to one embodiment, media sensor 54 is configured to provide indication to image translation module 72 in the form of initiation event 100 when the film type and/or manufacturing lot changes. According to one embodiment, when such an event occurs, image processing module 70 initiates the printing of test patches to calibrate inkjet printer 40.

According to one embodiment, image translation module 72 stores and accumulates densitometer data 98 over time in order to detect trends in overall performance of inkjet printing system 30. According to one embodiment, image translation module 72 stores and maintains a correction factors (a correction model) for each type and lot number of transparent film so that when such film is used again, image translation module 72 can simply retrieve and apply appropriate correction factors to the transparent film. According to one embodiment, if a specified duration of time has elapsed since a particular type of transparent was last used, image processing module 70 initiates a calibration process by printing the series of test patches and updating the corresponding correction model.

Although described above primarily with regard to monochromatic printing across a range of gray scale densities, the above techniques can also be applied to color printing. According to such embodiments, rather than printing a series of test patches, with each test patch having a gray scale density, image processing module initiates the printing of a series of test patches for each available color of printhead 42 (e.g. a series of test patches providing a density gradient for cyan, a series of test patches providing a density gradient for yellow, a series of test patches providing a density gradient for magenta, and a series of test patches providing a density gradient for black). The test patch gradients for each color are measured by densitometer 60 using appropriate color filters, and image processing module 70 determines correction factors for each color which are applied to the color values of the output pixels of output image data 92.

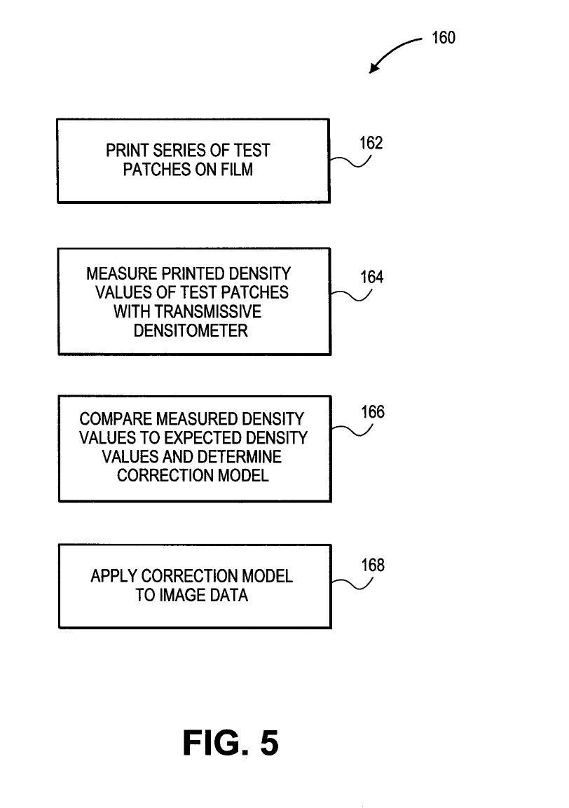

FIG. 5 shows a flow diagram generally illustrating one embodiment of a monochromatic inkjet printing system calibration process 160 employing test patches and a densitometer according to the present disclosure. Calibration process 160 begins at 162 with the printing of a series of test patches by an inkjet printhead on a sheet of transparent film, wherein each test patch has an expected gray scale density. At 164, a transmissive densitometer is used to measure the actual gray scale density of each of the test patches. At 166, based on a comparison of the actual measured gray scale densities to the expected gray scale densities of the series of test patches, a correction model is determined, such as the mapping of expected density values to adjusted density values. At 168, the correction model is applied to input image data so that image data printed by an inkjet printer of the inkjet print system has actual density values which closely match expected density values.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

It will be understood by a person of ordinary skill in the art that functions performed by image processing module 70 may be implemented in hardware, software, firmware, or any combination thereof. The implementation may be via a microprocessor, programmable logic device, or state machine Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory, and random access memory.

1. An inkjet printing system comprising:
a media source supplying sheets of transparent film;
an image processing module configured to receive and convert input image data to output image data comprising a plurality of output pixels, each output pixel having a pixel value, and configured to select for each output pixel, based on the pixel value, an ink profile from a set of predetermined ink profiles associated with each pixel value, wherein the image processing module, in response to an initiating event, selects predetermined ink profiles representative of a series of test patches each having an expected density;
an inkjet printer including a printhead configured to eject droplets of one or more available colors of ink onto a sheet of transparent film based on the selected ink profiles so as to produce the output pixels and an output image thereon, including the series of test patches; and
a transmissive densitometer which measures an actual density value of each of the test patches from the transparent film, wherein the image processing module adjusts the output pixel values based on deviations between the expected and actual density values of the series of test patches.

2. The inkjet printing system of claim 1, wherein the densitometer is integral to the inkjet printer.

3. The inkjet printing system of claim 1, wherein the output image data comprises monochromatic image data, and wherein the expected densities of the series of test patches comprise gray scale densities, each test patch having a different expected gray scale density.

4. The inkjet printing system of claim 3, wherein the series of test patches represent discrete gray scale density samples across a range of gray scale densities capable of being printed by the printhead, and wherein the image processing module derives a curve of actual density values across the range of gray scale densities from the measured actual gray scale density values of the test patches, wherein the image processing module forms a correction model based on differences between the curve of actual density values and a curve of expected density values across the range of gray scale densities, and wherein the image processing module adjusts pixel values of the output pixels based on the correction model so that actual density values of printed output pixels substantially matches expected density values.

5. The inkjet printing system of claim 1, wherein the printhead prints a plurality of series of test patches in response to the initiating event, and wherein the image processing module adjusts the output pixel values based on a deviations between the expected density values of the test patches and average values of the actual density values of each of the series of test patches.

6. The inkjet printing system of claim 1, wherein the output image data comprises color image data, and wherein the series of test patches comprise a plurality of series of test patches, with each series of test patches representing densities across a range of densities for each available color of the printhead.

7. The inkjet printing system of claim 6, wherein the image processing module adjusts the pixel values of each color of the output pixels based on deviations between the expected and actual density values of the series of test patches for each available color of the printhead.

8. The inkjet printing system of claim 1, wherein the initiation event comprises a calibration request by a user of the inkjet printing system.

9. The inkjet printing system of claim 1, wherein the initiation event comprises a change in a type and/or manufacturing lot of the transparent film.

10. The inkjet printing system of claim 1, wherein the initiation even comprises the elapsing of a specified duration of time.

11. The inkjet printing system of claim 1, including an image sensor configured to read parameters associated with the sheets of transparent film from indicia affixed thereto, the parameters including indications of film type and film manufacturing lot.

12. The inkjet printing system of claim 11, wherein the image processing module develops a correction model for each combination of film type and film manufacturing lot based on deviations between expected and actual density values of a series of test patches associated with each combination of film type and film manufacturing lot.

13. A monochromatic inkjet printing system comprising:
a media source providing sheets of transparent film;
an image processing module receiving and converting input image data to output image data comprising a plurality of output pixels, each output pixel having a gray scale density value, and configured to select for each output pixel a predetermined ink profile corresponding to the gray scale gray scale density value, and in response to an calibration event, configured to select a series of predetermined ink profiles representative of a series of test patches each having an expected gray scale density; and
an inkjet printer including a transmissive densitometer and printhead, the printhead configured to eject droplets of one or more available colors of ink onto a sheet of transparent film based on the selected ink profiles to print the output pixels and a corresponding image formed thereby on the transparent film and to print the test patches thereon in response to the calibration event, wherein densitometer is configured to measure an actual gray scale density value of each of the printed test patches, and wherein the image processing module adjusts the gray scale density value of the output pixels based on differences between the expected and actual gray scale density values of the series of test patches.

14. The monochromatic inkjet printing system of claim 13, wherein the series of test patches represent discrete gray scale density values spaced across a complete range of gray scale density values capable of being printed by the printhead.

15. The monochromatic inkjet printing system of claim 14, wherein the image processing module determines a derived curve of actual gray scale density values across the complete range of gray scale density values being printed by the printhead based on the measured discrete gray scale density values of the test patches, determines a correction model based on differences between the derived curve and a curve of expected gray scale density values across the complete range of gray scale density values, and adjusts the gray scale density values of the output pixels based on the correction model so that the actual gray scale densities of the printed output pixels substantially matches desired gray scale density values of the output pixels.

16. The monochromatic inkjet printing system of claim 13, wherein the transparent film can be of different film types and from different manufacturing lots, and wherein the image processing module, over time, determines a correction model for each combination of film type and manufacturing lot and employs the correction model corresponding to the film type and manufacturing lot being employed at a given time.

17. A method of inkjet printer calibration comprising:
printing a series of test patches on a sheet of transparent film with a printhead of the inkjet printer, each test patch having a different expected gray scale density value, the series of test patches together representing discrete gray scale density values across a full range of gray scale density values capable of being printed by the printhead;
measuring the actual gray scale density of each of the test patches with a transmissive densitometer;
determining a correction model based on differences between the expected and actual gray scale density values of the test patches; and
adjusting pixel values of pixels of monochromatic image data to be printed by the printhead using the correction model so that actual gray scale values of the printed pixels substantially matches expected values of the pixels of monochromatic image data.

18. The method of claim 17, wherein determining a correction model includes:
deriving a curve of actual density values across the range of gray scale densities from the measured actual gray scale density values of the test patches; and
forming the correction model based on differences between the curve of actual density values and a curve of expected density values across the range of gray scale densities.

19. The method of claim 17, wherein printing the series of test patches includes printing a plurality of series of test patches, and wherein determining a correction model is based on differences between the expected gray scale density values of the test patches and averages of the measured actual gray scale density values of the test patches at each of the discrete gray scale density values.

20. The method of claim 17, including integrating the densitometer with the inkjet printer.
